(19) United States
(12) Patent Application Publication
(10) Pub. No.: US 2025/0373862 A1
(43) Pub. Date: Dec. 4, 2025

(54) BEAM SEARCH-BASED JOINT RATE-DISTORTION OPTIMIZATION ALGORITHM FOR VVC INTRA CODING

(71) Applicant: CITY UNIVERSITY OF HONG KONG, Kowloon (HK)

(72) Inventors: Shiqi WANG, Kowloon (HK); Yingwen ZHANG, Kowloon (HK)

(73) Assignee: CITY UNIVERSITY OF HONG KONG, Kowloon (HK)

(21) Appl. No.: 18/678,956

(22) Filed: May 30, 2024

(51) Int. Cl. H04N 19/96

(52) U.S. Cl. CPC H04N 19/96

(57) ABSTRACT

A computer-implemented method for optimizing a video encoder. The method includes the step of defining a plurality of CUs of the video encoder that correspond to a plurality of stages. The plurality of stages includes at least a first stage, and a second stage immediately after the first stage. The method further includes the steps of providing a decision space of encoding parameters of the video encoder, and defining, for the second stage, a subspace being a subset of the decision space. The subspace contains b₁ optimal decision paths from the first stage to the second stage, wherein b₁ is defined as a beam size for the first stage. The b₁ optimal decision paths are the b₁ decision paths that have lowest accumulated cost among all decision paths from the first stage to the second stage.

### FIELD OF INVENTION

This invention relates to video coding, and in particular to optimization of video encoders.

### BACKGROUND OF INVENTION

Exploring rate-distortion (R-D) bounds is a long-standing problem in video coding [1] or, in a broader sense, source coding [2]. Such a bound determines the possible compression rate under a certain level of permitted distortion. On the other hand, the bound provides meaningful guidance to the community for designing efficient coding algorithms. Generally, R-D bounds can be either informational or operational [3]. The former has long been studied, relying on the modeling of mutual information and its variants. However, it is achievable only when the source follows certain assumptions (e.g., independent and identically distributed). The latter specifies the best achievable R-D points based on a certain encoding scheme. As such, the operational R-D bounds are always under exploration, as new coding techniques continue to emerge.

One way to improve the operational R-D bound is to introduce more efficient coding tools. More specifically, in the latest versatile video coding (VVC) standard, by enabling larger coding tree units (CTUs) and transform sizes [4]; partitioning structures for multitype trees (MTTs) [5]; dependent quantization (DQ) [6]; filtering techniques [7] such as luma mapping with chroma scaling (LMCS) [8] and the adaptive loop filter (ALF) [9]; and intra tools [10] such as multiple reference lines (MRL) [11], matrix-based intra prediction (MIP) [12], intra subpartition (ISP) [13], multiple transform selection (MTS) [4], the low-frequency non-separable transform (LFNST) [14], block-level differential pulse code modulation (BDPCM) [15] and intra block copying (IBC) [16], more than 25% Bjøntegaard Delta bit-rate (BDBR) [17] reductions have been achieved over its predecessor, i.e., high-efficiency video coding (HEVC) [18], under the all-intra (AI) configuration [19].

Another strategy for exploring the R-D bound is optimizing the decision process in the encoder. In particular, the coding mode decisions, such as coding unit (CU) partitioning and prediction modes, are determined by the unconstrained rate-distortion optimization (RDO) [1] process with Lagrangian parameters. To make the encoder computationally practicable for real-world applications, the RDO process may ignore the dependencies among different CUs, thus yielding a “reasonably good” greedy solution [20]. In the descriptions herein, the “CU” and “macroblock (MB)” concepts are unified and merely use “CUs” to represent the basic coding units from different standards. As pointed out in [21], due to the involvement of predictive coding and entropy coding techniques, the performance of the current CU is highly dependent on the quality and contexts of the previously coded CUs. In other words, joint optimization, which considers the neighboring CUs when optimizing the current CU, is of prominent importance for pushing the R-D performance bounds.

Undoubtedly, when the neighboring CUs' decisions are jointly optimized, it is practically feasible to obtain better operational R-D performance. In the literature, joint optimization schemes that consider the dependencies among neighboring CUs have been developed, exploring new achievable bounds for H.262/MPEG-2 [22], [23], H.263 [24], [25], [26], H.264/AVC [27], and H.265/HEVC [28] encoders. However, applying these methods in VVC intra coding in a straightforward manner is still very challenging as more flexible partition structures and more advanced coding techniques are introduced.

### REFERENCES

The following references are referred to throughout this specification, as indicated by the numbered brackets. The disclosures of each of these references are hereby incorporated by reference herein in their entireties for all purposes.
[1] G. J. Sullivan and T. Wiegand, “Rate-distortion optimization for video compression,” IEEE Signal Process. Mag., vol. 15, no. 6, pp. 74-90, November 1998.
[2] T. Berger, “Rate-distortion theory,” in Wiley Encyclopedia of Telecommunications. Hoboken, NJ, USA: Wiley, 2003.
[3] Thomas M. Cover, Elements of Information Theory. Hoboken, NJ, USA: Wiley, 1999.
[4] X. Zhao et al., “Transform coding in the VVC standard,” IEEE Trans. Circuits Syst. Video Technol., vol. 31, no. 10, pp. 3878-3890, October 2021.
[5] Y.-W. Huang et al., “Block partitioning structure in the VVC standard,” IEEE Trans. Circuits Syst. Video Technol., vol. 31, no. 10, pp. 3818-3833, October 2021.
[6] H. Schwarz et al., “Quantization and entropy coding in the versatile video coding (VVC) standard,” IEEE Trans. Circuits Syst. Video Technol., vol. 31, no. 10, pp. 3891-396, October 2021.
[7] M. Karczewicz et al., “VVC in-loop filters,” IEEE Trans. Circuits Syst. Video Technol., vol. 31, no. 10, pp. 3907-3925, October 2021.
[8] T. Lu et al., “Luma mapping with chroma scaling in versatile video coding,” in Proc. Data Compress. Conf. (DCC), March 2020, pp. 193-202.
[9] C.-Y. Tsai et al., “Adaptive loop filtering for video coding,” IEEE J. Sel. Topics Signal Process., vol. 7, no. 6, pp. 934-945, December 2013.
[10] J. Pfaff et al., “Intra prediction and mode coding in VVC,” IEEE Trans. Circuits Syst. Video Technol., vol. 31, no. 10, pp. 3834-3847, December 2021.
[11] J. Li, B. Li, J. Xu, and R. Xiong, “Efficient multiple-line-based intra prediction for HEVC,” IEEE Trans. Circuits Syst. Video Technol., vol. 28, no. 4, pp. 947-957, April 2018.
[12] J. Pfaff et al., “Neural network based intra prediction for video coding,” Proc. SPIE, vol. 10752, pp. 359-365, January 2018.
[13] S. De-Luxán-Hernández et al., “An intra subpartition coding mode for VVC,” in Proc. IEEE Int. Conf. Image Process. (ICIP), September 2019, pp. 1203-1207.
[14] M. Koo, M. Salehifar, J. Lim, and S.-H. Kim, “Low frequency non-separable transform (LFNST),” in Proc. Picture Coding Symp. (PCS), November 2019, pp. 1-5.
[15] M. Abdoli, F. Henry, P. Brault, F. Dufaux, P. Duhamel, and P. Philippe, “Intra block-DPCM with layer separation of screen content in VVC,” in Proc. IEEE Int. Conf. Image Process. (ICIP), September 2019, pp. 3162-3166.
[16] X. Xu et al., “Intra block copy in HEVC screen content coding extensions,” IEEE J. Emerg. Sel. Topics Circuits Syst., vol. 6, no. 4, pp. 409-419, December 2016.
[17] G. Bjontegaard, Calculation of Average PSNR Differences Between RD-Curves, document VCEG-M33, 2001.
[18] G. J. Sullivan, J.-R. Ohm, W.-J. Han, and T. Wiegand, “Overview of the high efficiency video coding (HEVC) standard,” IEEE Trans. Circuits Syst. Video Technol., vol. 22, no. 12, pp. 1649-1668, December 2012.
[19] B. Frank, Li Xiang, S. Karsten, S. Karl, S. Vadim, and T. Alexis, JVET AHG Report: Test Model Software Development (AHG3), document JVET-W0003-v1, Joint Video Exploration Team, Teleconference, July 2021.
[20] T. Wiegand and H. Schwarz, “Video coding: Part II of fundamentals of source and video coding,” Found. Trends® Signal Process., vol. 10, nos. 1-3, pp. 1-346, 2016.
[21] A. Ortego and K. Ramchandran, “Rate-distortion methods for image and video compression,” IEEE Signal Process. Mag., vol. 15, no. 6, pp. 23-50, February 1998.
[22] H. Sun, W. Kwok, M. Chien, and C. H. J. Ju, “MPEG coding performance improvement by jointly optimizing coding mode decisions and rate control,” IEEE Trans. Circuits Syst. Video Technol., vol. 7, no. 3, pp. 449-458, June 1997.
[23] E.-H. Yang and L. Wang, “Full rate distortion optimization of MPEG-2 video coding,” in Proc. 16th IEEE Int. Conf. Image Process. (ICIP), November 2009, pp. 605-608.
[24] T. Wiegand, M. Lightstone, D. Mukherjee, T. G. Campbell, and S. K. Mitra, “Rate-distortion optimized mode selection for very low bit rate video coding and the emerging H.263 standard,” IEEE Trans. Circuits Syst. Video Technol., vol. 6, no. 2, pp. 182-190, April 1996.
[25] D. Mukherjee and S. K. Mitra, “Combined mode selection and macroblock quantization step adaptation for the H.263 video encoder,” in Proc. Int. Conf. Image Process., 1997, pp. 37-40.
[26] M. C. Chen and A. N. Willson, “Rate-distortion optimal motion estimation algorithms for motion-compensated transform video coding,” IEEE Trans. Circuits Syst. Video Technol., vol. 8, no. 2, pp. 147-158, April 1998.
[27] W. Xiao, J. Xu, F. Wu, and G. Shi, “Joint rate-distortion optimization for H.264/AVC intra coding based on cluster computing,” in Proc. IEEE Int. Symp. Circuits Syst. (ISCAS), May 2012, pp. 1548-1551.
[28] M. Bichon, J. Le Tanou, M. Ropert, W. Hamidouche, L. Morin, and L. Zhang, “Inter-block dependencies consideration for intra coding in H.264/AVC and HEVC standards,” in Proc. IEEE Int. Conf. Acoust., Speech Signal Process. (ICASSP), March 2017, pp. 1537-1541.
[29] J. You, C. Choi, and J. Jeong, “Modified rate distortion optimization using inter-block dependence for H.264/AVC intra coding,” IEEE Trans. Consum. Electron., vol. 54, no. 3, pp. 1383-1388, August 2008.
[30] G. D. Forney Jr., “The Viterbi algorithm,” Proc. IEEE, vol. 61, no. 3, pp. 268-278, March 1973.
[31] G. M. Schuster and A. K. Katsaggelos, “A video compression scheme with optimal bit allocation among segmentation, motion, and residual error,” IEEE Trans. Image Process., vol. 6, no. 11, pp. 1487-152, November 1997.
[32] S. J. Russell, Artificial Intelligence a Modern Approach. London, U.K.: Pearson, 2010.
[33] M. Lightstone, D. Miller, and S. K. Mitra, “Entropy-constrained product code vector quantization with application to image coding,” in Proc. 1st Int. Conf. Image Process., 1994, pp. 623-627.
[34] E.-H. Yang and X. Yu, “Rate distortion optimization for H.264 inter-frame coding: A general framework and algorithms,” IEEE Trans. Image Process., vol. 16, no. 7, pp. 1774-1784, July 2007.
[35] X. Wang, E.-H. Yang, D.-K. He, L. Song, and X. Yu, “Rate distortion optimization: A joint framework and algorithms for random access hierarchical video coding,” IEEE Trans. Image Process., vol. 29, pp. 9458-9469, 2020.
[36] M. C. Chen and A. N. Willson, “Motion-vector optimization of control grid interpolation and overlapped block motion compensation using iterated dynamic programming,” IEEE Trans. Image Process., vol. 9, no. 7, pp. 1145-1157, July 2000.
[37] R. Bellman, “Dynamic programming,” Science, vol. 153, no. 3731, pp. 34-37, July 1966.
[38] VVC Software Repository. Accessed: Feb. 17, 2021. [Online]. Available: https://vcgit.hhi.fraunhofer.de/jvet/VVCSoftware_VTM/-/tree/VTM-12.0
[39] P. Yinji, M. Junghye, and C. Jianle, “Encoder improvement of unified intra prediction,” document JCTVC-C207, Joint Collaborative Team on Video Coding, January 2013.
[40] B. Bross, J. Chen, S. Liu, and Y.-K. Wang, Versatile Video Coding Editorial Refinements on Draft 10, document JVET-T2001, Joint Video Exploration Team, Teleconference, October 2020.
[41] D. Marpe et al., “Video compression using nested quadtree structures, leaf merging, and improved techniques for motion representation and entropy coding,” IEEE Trans. Circuits Syst. Video Technol., vol. 20, no. 12, pp. 1676-1687, December 2010.
[42] A. Wieckowski, J. Ma, H. Schwarz, D. Marpe, and T. Wiegand, “Fast partitioning decision strategies for the upcoming versatile video coding (VVC) standard,” in Proc. IEEE Int. Conf. Image Process. (ICIP), September 2019, pp. 4130-4134.
[43] B. Frank, B. Jill, Li Xiang, S. Vadim, and S. Karsten, VTM Common Test Conditions and Software Reference Configurations for SDR Video, document JVET-T2010, Joint Video Exploration Team, Teleconference, October 2020.
[44] B. Bross, K. Heiner, C. Bartnik, P. Mark, and M. Detlev, AHG4: Multiformat Berlin Test Sequences, document JVET-Q0791, Joint Video Exploration Team, Brussels, Belgium, January 2020.
[45] B. Bross, J. Chen, J.-R. Ohm, G. J. Sullivan, and Y.-K. Wang, “Developments in international video coding standardization after AVC, with an overview of versatile video coding (VVC),” Proc. IEEE, vol. 109, no. 9, pp. 1463-1493, September 2021.
[46] N. Seshadri and C.-E.-W. Sundberg, “List Viterbi decoding algorithms with applications,” IEEE Trans. Commun., vol. 42, no. 2, pp. 313-323, February 1994.
[47] T. Li, M. Xu, R. Tang, Y. Chen, and Q. Xing, “DeepQTMT: A deep learning approach for fast QTMT-based CU partition of intra-mode VVC,” IEEE Trans. Image Process., vol. 30, pp. 5377-5390, 2021.
[48] S. Wu, J. Shi, and Z. Chen, “HG-FCN: Hierarchical grid fully convolutional network for fast VVC intra coding,” IEEE Trans. Circuits Syst. Video Technol., vol. 32, no. 8, pp. 5638-5649, August 2022.

### SUMMARY OF INVENTION

Accordingly, the present invention, in one aspect, is a computer-implemented method for optimizing a video encoder. The method includes the step of defining a plurality of CUs of the video encoder that correspond to a plurality of stages. The plurality of stages includes at least a first stage, and a second stage immediately after the first stage. The method further includes the steps of providing a decision space of encoding parameters of the video encoder, and defining, for the second stage, a subspace being a subset of the decision space. The subspace contains b₁ optimal decision paths from the first stage to the second stage, wherein b₁ is defined as a beam size for the first stage. The b₁ optimal decision paths are the b₁ decision paths that have lowest accumulated cost among all decision paths from the first stage to the second stage.

In some embodiments, the plurality of stages further contains a third stage immediately before the first stage. The method further contains the step of truncating dependencies between the third stage and the first stage.

In some embodiments, the step of truncating dependencies between the third stage and the first stage further includes reducing the number of decision paths from the third stage to the first stage to one.

In some embodiments, a third CU corresponding to the third stage is at CTU level.

In some embodiments, a third CU corresponding to the third stage is from a different partitioning depth compared to that of a first CU corresponding to the first stage.

In some embodiments, the plurality of stages further contains a third stage immediately after the second stage; the method further contains defining, for the third stage, a subspace being a subset of the decision space. The subspace contains b₂ optimal decision paths from the first stage to the third stage. b₂ is defined as a beam size for the second stage. The b₂ optimal decision paths are the b₂ decision paths that have lowest accumulated cost among all decision paths from the first stage to the stage.

In some embodiments, b₁ is different from b₂.

In some embodiments, b₁ is the same as b₂.

In some embodiments, the b₂ optimal decision paths are collected by a generalized Breiman, Friedman, Olshen and Stone (G-BFOS) algorithm. The G-BFOS algorithm is adapted to compare the b₂ optimal decision paths with those from one of the plurality of stages other than the first, second and third stages.

In some embodiments, the method further includes the step of determining a beam size for each of the plurality of stages.

In some embodiments, the beam size for each of the stages is determined based on characteristics of a corresponding one of the plurality of CUs.

In some embodiments, the characteristics of the corresponding CU include a width and a height of the corresponding CU.

In some embodiments, the decision space contains partitioning decision, prediction decisions or transform decisions.

In some embodiments, the video encoder is VVC.

According to another aspect of the invention, there is provided a non-transitory computer-readable memory recording medium having computer instructions recorded thereon, the computer instructions, when executed on one or more processors, causing the one or more processors to perform operations according to the method(s) described above.

According to a further aspect of the invention, there is provided a computing system that includes one or more processors, and memory containing instructions that, when executed by the one or more processors, cause the computing system to perform operations according to the method(s) described above.

One can see that embodiments of the invention therefore provide a beam search-based optimization scheme that for example may jointly optimize the partitioning, prediction and transform decisions across different CUs for VVC intra coding. The optimization scheme is computationally scalable, enabling finer granularity with the non-uniform configuration of the beam size, which can serve as a practical encoder optimization solution for applications with different computational capacities. The optimization scheme is implementation-friendly and fully conforms to decoding syntax of existing video codec, such as the VVC decoding syntax, which can easily be deployed.

The foregoing summary is neither intended to define the invention of the application, which is measured by the claims, nor is it intended to be limiting as to the scope of the invention in any way.

### BRIEF DESCRIPTION OF FIGURES

The foregoing and further features of the present invention will be apparent from the following description of embodiments which are provided by way of example only in connection with the accompanying figures, of which:

FIG. 1 is an illustration of QT-MTT partitioning in VVC (the presented partition pattern is determined by 15 leaf-node CUs).

FIG. 2 shows a flowchart for the RDO process of intra encoding in the VTM.

FIG. 3 illustrates the Viterbi algorithm under the 1st-order Markov assumption. q=3, and the decision space [symbol] ={α, β, χ}.

FIG. 4 is an illustration of a beam search-based joint rate-distortion optimization (BSJRDO) scheme according to one embodiment of the invention, which has a decision space of M={α, β, χ} and a beam size of b=2.

FIG. 5 is a table illustrating the performance achieved by the BSJRDO scheme with b=10 and s_{d}=64 under the VVC AI configuration.

FIG. 6a shows the performance bound of the BSJRDO scheme in terms of BDBR-Y result obtained using the Hadamard-based pre-selection.

FIG. 6b shows the performance bound of the BSJRDO scheme in terms of BDBR-V result obtained using the Hadamard-based pre-selection.

FIG. 6c shows the performance bound of the BSJRDO scheme in terms of BDBR-Y result obtained using the full-candidate search.

FIG. 6d shows the performance bound of the BSJRDO scheme in terms of BDBR-V result obtained using the full-candidate search.

FIG. 7a shows the scalability performance of BDBR-Y under the CTC in terms of R-D optimal points of the BSJRDO scheme under the default VVC AI configuration.

FIG. 7b shows the scalability performance of BDBR-V under the CTC in terms of R-D optimal points of the BSJRDO scheme under the default VVC AI configuration.

FIG. 7c shows the scalability performance of BDBR-Y under the CTC in terms of R-D optimal points of the BSJRDO scheme under an HEVC-like configuration.

FIG. 7d shows the scalability performance of BDBR-V under the CTC in terms of R-D optimal points of the BSJRDO scheme under the HEVC-like configuration.

FIG. 7e shows the performance comparison between the BSJRDO scheme and the RSVA in terms of BDBR-Y under the default VVC AI configuration.

FIG. 7f shows the performance comparison between the BSJRDO scheme and the RSVA in terms of BDBR-V under the default VVC AI configuration.

FIG. 7g shows the performance comparison between the BSJRDO scheme and the RSVA in terms of BDBR-Y under the HEVC-like configuration.

FIG. 7h shows the performance comparison between the BSJRDO scheme and the RSVA in terms of BDBR-V under the HEVC-like configuration.

FIG. 8a shows encoding samples with sizes of 64×32 from the BasketballPass sequence, when b=1.

FIG. 8a shows encoding samples with sizes of 64×32 from the BasketballPass sequence, when b=2.

### DETAILED DESCRIPTION

In the following descriptions, bold italicized lower-case letters, e.g., m, are used to denote random variables, while Roman-style (upright) lower-case letters, e.g., m, denote the instances of random variables. Bold italicized capital letters, e.g., M, denote the vectors of random variables (i.e., random vectors). Roman-style capital letters, e.g., M, denote the instances of random variables. Bold Roman-style capital letters, e.g., M, denote the two-dimensional vectors of random variables (i.e., random matrices). Calligraphic letters, e.g., [symbol] , denote the spaces of random variables or the vector spaces of the random vectors, depending on the context.

As will be explained in more details below, in one exemplary embodiment of the invention there is provided a BSJRDO scheme. The achievable R-D performance bound in VVC intra coding is expanded when considering the mutual dependency in RDO process. In particular, the abundant search space of encoding parameters provided in VVC intra coding is practically explored, where the partitioning, prediction and transform decisions are jointly optimized across different CUs with a customized search subset instead of the full space. Shrinking the candidate space of the trellis has been proven to be effective for alleviating the complexity issue. Another complexity reduction strategy for joint optimization is to divide the full product space into different subspaces. By sequentially and iteratively optimizing the subspaces, the computational complexity is subsequently reduced.

To make the beam search process implementation-friendly for VVC, the dependencies among the CUs are optionally truncated at different depths. The coding complexity is further reduced due to the truncation. To facilitate finer computational scalability, optionally the beam size is flexibly adjusted based on the characteristics of each of the encoding CUs, such that the operational points that satisfy different complexity demands for diverse applications can be practically obtained. The BSJRDO scheme, which fully conforms to the VVC decoding syntax, can serve as both the way toward the optimal RDO bound and a practical performance-boosting solution. In an experiment setup, the BSJRDO scheme is implemented on a VVC coding platform (VVC Test model (VTM) 12.0), and extensive experiments show that BSJRDO can achieve 1.30% and 3.22% bit rate savings compared to the VTM anchor under the common test condition and low-bit-rate coding scenarios, respectively. Moreover, the performance gain can also be flexibly customized with different computational overheads.

As skilled persons will understand, intra coding utilizes the spatial correlations of pixels within a picture and is of great importance for providing random access, handling large motions, and avoiding error propagation in video coding. However, in conventional art, most schemes attempt to optimize the intra coding process with the full space of certain decisions. As advanced partitioning (MTT) and transform (MTS/LFNST) schemes in VVC provide two extra coding dimensions, the decision space is growing drastically. Therefore, the existing full-space exhaustive optimization approach is not suitable for VVC considering its enormous computational cost. In addition to the joint optimization method in intra coding, numerous works have explored the dependencies of CUs in inter coding, ranging from H.262/MPEG-2 to H.265/HEVC. Among them, the most established method is the Viterbi algorithm [22], [24], [30], where the optimal solution can be elegantly derived over a trellis. However, as the original Viterbi algorithm may also be viewed as a type of full-space optimization approach, its computational burden is still heavy in practice. To tackle this, low-complexity schemes have been proposed to make the joint optimization process more tractable.

In the next section, the intra encoding process in the VTM is overviewed. Then, the joint RDO problem that considers the mutual dependencies between different CUs is formulated. Such a formulation is intrinsically a multistage decision process [37], where sequential decisions should be made, and the current decision depends on all the previous decisions. How this problem can be simplified and solved with greedy and Viterbi algorithms will be discussed.

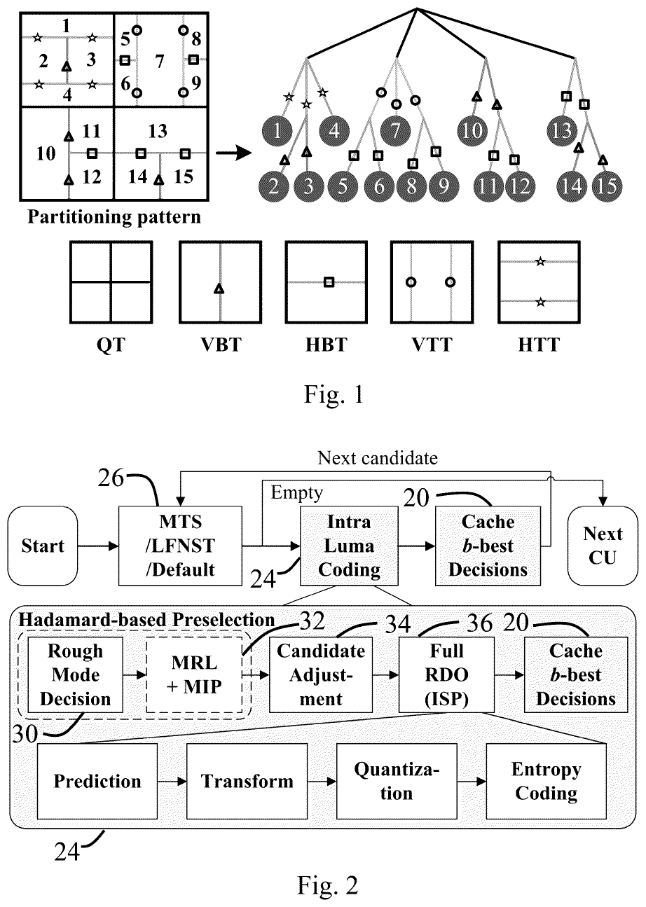

In VVC, for a CTU with 128×128 samples, the QT is first performed to obtain four 64×64 child CUs. The child CUs are then recursively partitioned with the quadtree with multitype tree (QT-MTT) scheme to attain sub-CUs. After these processes a plurality of CUs can be defined for the VVC. At most five types of trees, i.e., the QT and MTT of the vertical binary tree (VBT), the horizontal binary tree (HBT), the vertical ternary tree (VTT) and the horizontal ternary tree (HTT), can be applied. Once the MTT is adopted in the child CUs, the QT is forbidden in the subsequent partitioning step [5]. An illustration of the QT-MTT partitioning process is shown in FIG. 1, where the partitioning pattern can be appropriately represented by a tree with 15 leaf nodes. For each leaf-node CU, the combination of the intra prediction modes and transform modes with the lowest R-D cost is obtained according to the RDO criteria [1].

A flowchart for the RDO process of intra coding in the VTM (modified from VTM-12.0 [38]) is illustrated in FIG. 2 according to one embodiment of the invention. It should be noted that the screen content and chroma coding modes are intentionally omitted in FIG. 2. Compared to the VTM-12.0 default AI configuration, the embodiment of the invention includes a step 20 of caching b-best decisions after intra luma coding 24, and the b-best decisions are provided to the MTS/LFNST/Default 26 for the next candidate list. The details of the intra luma coding 24 is also shown in FIG. 2. Herein, after setting one of the testing transform candidates (MTS, LFNST or default DCT-II) in Step 26, the corresponding best prediction decision is determined. As shown in FIG. 2, to reduce the complexity of conducting full RDO (i.e., prediction, transform, quantization and entropy coding) for all the possible candidates, Hadamard-based preselection is conducted. First, the rough mode decision (RMD) process is performed in Step 30 to preselect candidates from 67 regular modes (DC, planar and 65 angular modes). Subsequently, MRL and MIP are examined in Step 32. For MRL, only the 6 most probable modes (MPMs) derived from the adjacent left and top CUs are applied to the 3 different references of the MRL. For MIP, depending on the CU size, the maximum number of MIP candidates is 16. For each aforementioned step, a candidate list is updated based on their Hadamard costs. After that, an extra adjustment is made in Step 34 to the candidate list based on the conditions of the mode type, the Hadamard cost and the MPMs. Together with the possible ISP modes (split vertically or horizontally with 2 or 4 subblocks), the full RDO process is conducted in Step 36, and the maximum number of RDO candidates can be larger than 10. Finally, after iterating all the possible transform modes, the best combination of prediction and transform is attained in Step 20. It is worth mentioning that some combinations such as ISP with explicit MTS [4] are forbidden in the specification due to the complexity-efficiency tradeoff. For more details on VVC technologies, one may refer to [4], [5], [10], and [40].

As discussed above, for one leaf-node CU Xᵢ, the free coding parameters that can be optimized include the prediction modes pᵢ and transform modes tᵢ. If Xᵢ is a non-leaf CU, let l(zᵢ) be the number of leaf-node CUs for the partitioning pattern zᵢ. For zᵢ, it is an index random variable for which the possible instances are integers from {1, 2, . . . }, representing one of the patterns. For instance, in FIG. 1, suppose that a CU has the presented pattern and no partition of two possible patterns. Let zᵢ=1 represent the partitioned pattern and zᵢ=2 represent the pattern with no partition. Then, l(zᵢ=1)=15 and l(zᵢ=2)=1. For the j^{th} leaf-node CU under zᵢ, the decision S_{i,j}=(p_{i,j}, t_{i,j}), where the parameter space of S_{i,j} is the product space of {p_{i,j}}×{t_{i,j}}. Then, considering all the possible partitioning patterns of zᵢ, the full decision space provided for Xᵢ is the product space of {zᵢ}×{S_{i,1}}×{S_{i,2}} . . . ×{S_{i,l(z}_{ᵢ}₎}, which is denoted by [symbol] ᵢ. The RDO process [1] for Xᵢ is formulated as

$${min}_{{m}_{i}} {J}_{i} ( {m}_{i} ) , where {J}_{i} ( {m}_{i} ) = {D}_{i} ( {m}_{i} ) + λ {R}_{i} ( {m}_{i} ) , \qquad ( 1 )$$

and Jᵢ, Rᵢ and Dᵢ are the Lagrangian cost, rate and distortion for Xᵢ, respectively; mᵢ∈ [symbol] ᵢ is the coding decision of Xᵢ; and λ is the Lagrangian multiplier. Given n non-leaf CUs (e.g., n CTUs), the joint RDO problem is denoted by

$${min}_{{M}_{n}} {\sum }_{i = 1}^{n} {J}_{i} ( {M}_{i} ) , \qquad ( 2 )$$

where Mᵢ=(mᵢ, mᵢ₋₁, . . . , m₁) represents the decision vector or the decision path from X₁ to Xᵢ. Considering the coding dependencies of CUs, ideally, the current coding decision mᵢ should be dependent on all the previous decisions from m₁ to mᵢ₋₁. Noticeably, the long dependencies among CUs produce an exponential O(qⁿ) search space for obtaining the global optimal solution of Mₙ, where q=max {| [symbol] ₁|, . . . , | [symbol] ₙ|} is the general size of the CU decision space. To make this problem tractable, in practice, the decision of the current CU mᵢ is assumed to be independent of the previous decisions (mᵢ₋₁, . . . , m₁). The joint RDO process in Eqn. (2) is thus simplified as

$${min}_{{M}_{n}} {\sum }_{i = 1}^{n} {J}_{i} ( {M}_{i} ) \approx {min}_{{M}_{n}} {\sum }_{i = 1}^{n} {J}_{i} ( {m}_{i} ) = {\sum }_{i = 1}^{n} {min}_{{m}_{i}} {J}_{i} ( {m}_{i} ) \qquad ( 3 )$$

Therefore, by solving the RDO process of each CU sequentially and independently, the greedy (i.e., local optimum) solution can be obtained. The complexity or number of searches for Eqn. (3) is O(nq).

However, finding the best solution of mᵢ in [symbol] ᵢ is still a nontrivial problem due to the numerous possible partitioning patterns of zᵢ. One typical example is illustrated in [41], which considers QT partitioning alone. In particular, the parameter space of {zᵢ} exceeds 2⁴^{^{d-1}}, where d is the maximum allowable partitioning depth for this CU. For example, the number of possible partitioning patterns of zi is greater than 65536 when d=3. In VVC, the number of patterns can be even larger, as the number of partitioning modes has become 5. To shrink the search space of the partitioning patterns, the generalized G-BFOS algorithm [41] is usually adopted in practical implementations. Herein, from the bottom leaf-node CUs to the top root CU of a partitioning tree, the encoder recursively compares the best decision of the parent CU with that of its partitioned child CUs. Let mₚ be the best decision of the parent CU Xₚ obtained thus far, and

$$( {m}_{{c}_{1}} , … , {m}_{{c}_{l ( {z}_{c} )}} )$$

be the best descisions of the child CUs

$${X}_{{c}_{1}} , … , {X}_{{c}_{l ( {z}_{c} )}}$$

of Xₚ, respectively, under one of the 5 partitioning choices of the QT-MTT, denoted by z_{c}. The child decisions are assumed to be independent of each other, and if the following criterion is satisfied:

$${J}_{p} ( {m}_{p} ) \leq {\sum }_{j = 1}^{l ( {z}_{c} )} {J}_{{c}_{j}} ( {m}_{{c}_{j}} ) \qquad ( 4 )$$

the decisions of the child CUs are pruned without further consideration. Otherwise, the decision

$$( {z}_{c} , {m}_{{c}_{1}} , … , {m}_{{c}_{l ( {z}_{c} )}} )$$

replace the best decision mₚ of the parent node. With such a pruning mechanism, the partitioning space is considerably reduced, and the number of comparisons performed using Eqn. (4) is only on the order of the internal number of nodes in a partitioning tree considering QT only [41].

The greedy scheme features decent coding complexity at the expense of sacrificed coding performance. To achieve better R-D performance, the dependencies between different CUs can be further utilized. In the literature [22], [23], [24], [26], [31], [34], [36], such dependencies in inter coding have been modeled or converted to a 1^{st}-order Markov process and solved. Under a more general k^{th}-order Markov assumption, the joint RDO process in Eqn. (2) becomes

$$\begin{matrix}{min}_{{M}_{n}} {\sum }_{i = 1}^{n} {J}_{i} ( {M}_{i}^{k} ) , \\ where {M}_{i}^{k} = \{ \begin{matrix}( {m}_{i} , {m}_{i - 1} , … , {m}_{i - k} ) & i > k \geq 0 \\ ( {m}_{i} , {m}_{i - 1} , … , {m}_{1} ) & 1 \leq i \leq k\end{matrix}\end{matrix} \qquad ( 5 )$$

Herein, the current decision mᵢ considers the previous k CUs' decisions, and

$${M}_{i}^{k}$$

is the corresponding decision vector for Xᵢ. The optimal solution of Eqn. (5) can be obtained by dynamic programming or the Viterbi algorithm [30]. Let

$${C}_{i} ( {M}_{i}^{k - 1} )$$

be the best accumulated Lagrangian cost at Xᵢ with the decision

$${M}_{i}^{k - 1} .$$

For the initial stage 1≤i≤k,

$${C}_{i} ( {M}_{i}^{k - 1} ) = {\sum }_{x = 1}^{i} {J}_{x} ( {M}_{x}^{k} ) \qquad ( 6 )$$

Then, in the Xᵢ₊₁ stage (i≥k), the accumulated cost with

$${M}_{i + 1}^{k - 1}$$

is updated by

$${C}_{i + 1} ( {M}_{i + 1}^{k - 1} ) = {min}_{{m}_{i - k + 1}} {C}_{i} ( {M}_{i}^{k - 1} ) + {J}_{i + 1} ( {m}_{i + 1} , {M}_{i}^{k - 1} ) \qquad ( 7 )$$

where the optimal mᵢ₋ₖ₊₁ for

$${M}_{i + 1}^{k - 1}$$

is determined and updated in the tables for backtracking. Since the parameter space of the decision

$${M}_{i + 1}^{k - 1}$$

is bounded by q^{k}, at most q^{k} corresponding paths of Mᵢ₋ₖ₊₁=(mᵢ₋ₖ₊₁, . . . , m₁) are stored. When this updating process reaches the last CU Xₙ, the optimal decision of

$${M}_{n}^{k - 1} ,$$

denoted by

$${M}_{i + 1}^{k - 1} ,$$

is given by

$${M}_{n , 1}^{k - 1} = arg {min}_{{M}_{n}^{k - 1}} {C}_{n} ( {M}_{n}^{k - 1} ) \qquad ( 8 )$$

Together with the corresponding optimal path of Mₙ₋ₖ for

$${M}_{n , 1}^{k - 1}$$

stored in the tables, denoted by M_{n-k,1}, the optimal solution of Mₙ is

$$( {M}_{n , 1}^{k - 1} , {M}_{n - k , 1} ) .$$

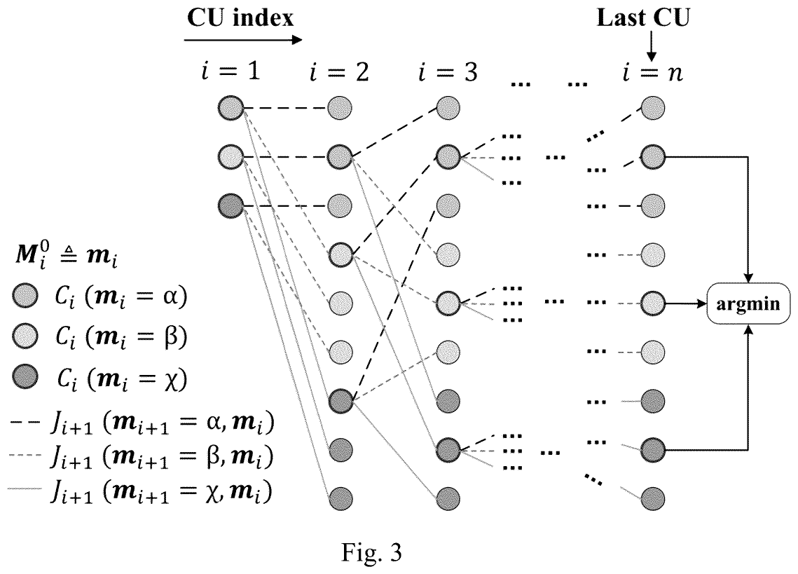

The overall complexity is O(ng^{k+1}) under the k^{th}-order Markov assumption. The Viterbi algorithm for a 1^{st}-order Markov decision process is illustrated in FIG. 3, where the entire process is represented by a trellis. Every stage includes q¹=3 states, and every state possesses a corresponding optimal updated path (backtracking the connected states with solid-line circles).For every stage, q^{k}=3 out of q^{k+1}=9 candidates are selected.

Although the joint RDO process can be neatly approached with the Viterbi algorithm, two main issues that may hinder its adoption in VVC intra coding remain. First, considering the decision space of the prediction, transform and partitioning of VVC intra coding, the computational complexity O(nq^{k+1}) can be magnified by hundreds of times compared that of to the greedy solution O(nq), even for k=1. Second, since the algorithm cannot obtain the optimal solution of Mₙ until it reaches the end of the trellis, the number of possible paths leading to the final solution is O(q^{k}), which may cause unacceptable memory consumption when caching for a large value of q.

Next, to address the simplified mutual independence of the greedy algorithm and the high complexity of the Viterbi algorithm, a BSJRDO scheme tailored for the VVC partitioning scheme according to an embodiment of the invention is provided. The key assumption of the scheme in this embodiment is that in every decision stage, the globally optimal decision may fall into a customized small subset which is a subspace. Instead of directly utilizing the best previous path or searching over the product decision space, only candidates from the subset are selected for the next stage. As such, CU dependencies are incorporated into the optimization process in a low-complexity manner. To make the scheme implementation-friendly, the dependencies between CUs derived from different partitioning depths are truncated. To facilitate finer computational scalability, the beam size is flexibly adjusted based on the characteristics of the CUS. To verify the effectiveness of this approach, the CU size is incorporated into the BSJRDO scheme as the condition. Finally, the relationship between the beam search in the embodiment and the corresponding RSVA [23], [26], [31] will be discussed.

For the RDO formulation in Eqn. (2), it is conceivable that most of the paths of Mᵢ are less beneficial for finding a better global solution. For example, for a picture with obvious vertical textures, the paths containing angular prediction decisions near the horizontal direction are less likely to be included in the final optimal solution. The same logic also applies to

$${M}_{i}^{k}$$

in Eqn. (5). Therefore, there is definitely room to shrink the decision space with an ignorable coding loss.

To this end, a function that can evaluate how “good” the decisions Mᵢ made thus far is appropriately devised. In [25], together with the accumulated Lagrangian cost, a look-ahead term that takes the uncoded mode cost of the next block was used to make the joint optimization process in H.263 work properly. For VVC intra coding, that idea was experimentally examined using the accumulated Lagrangian cost, as the evaluation measure has already produced a decent coding gain for the BSJRDO scheme. Let [symbol] ᵢ be the space with | [symbol] ᵢ|=bᵢ that contains the paths with the bᵢ lowest accumulated costs (i.e., bᵢ best paths) in stage Xᵢ; \tilde{M}ᵢ∈ [symbol] ᵢ⊂{mᵢ}× . . . ×{m₁} is one of these paths. Apparently, the space size bᵢ can be much smaller than the full space O(qⁱ) in Eqn. (2) and the Markovian space O(q^{k}) in Eqn. (7). In other words, [symbol] ᵢ is just a subspace being a subset of the full space. the For c and | [symbol] ᵢ₊₁|=bᵢ₊₁, the space is updated by the paths of (mᵢ₊₁, \tilde{M}ᵢ) with the bᵢ₊₁ lowest accumulated costs:

$${C}_{i + 1}^{′} ( {m}_{i + 1} , {\tilde{M}}_{i} ) = {C}_{i}^{′} ( {\tilde{M}}_{i} ) + {J}_{i + 1} ( {m}_{i + 1} , {\tilde{M}}_{i} ) \qquad ( 9 )$$

where the initial C′ᵢ(\tilde{M}₁)=J₁(\tilde{M}₁). Herein, the notation C′ is used with its superscript to differentiate the best cost C of certain decisions in the Viterbi solution. For the \tilde{M}ᵢ₊₁ updating step, at most qbᵢ calculations of Jᵢ₊₁(mᵢ₊₁, \tilde{M}ᵢ) are necessary. When the last CU Xₙ is updated, the best solution can be obtained by backtracking the path with the lowest cost

$${C}_{n}^{′} ( {\tilde{M}}_{n} ) .$$

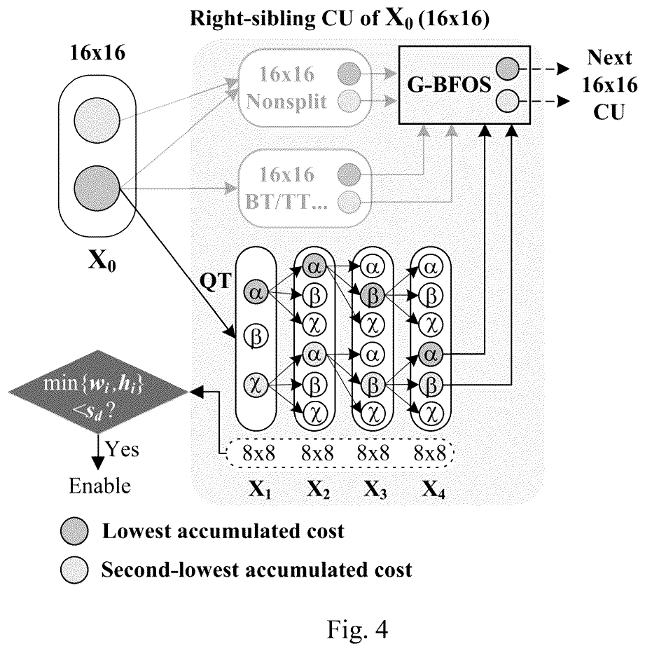

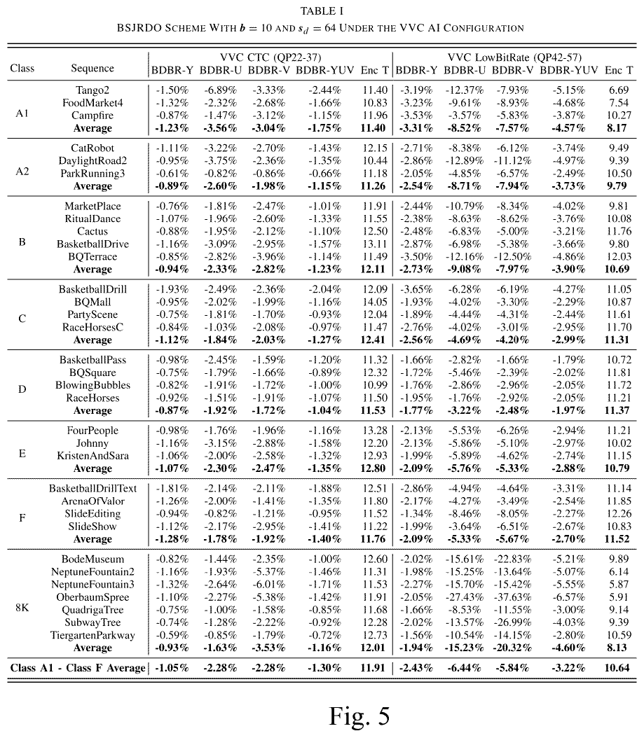

An illustration of the BSJRDO scheme is given in FIG. 4. X₀ is a CU at CTU level (therefore a non-leaf CU). In the right-sibling CU of X₀ (16×16), there is a nonsplit CU and a CU after BT/TT partitioning (which are greyed out in FIG. 4), as well as four 8×8 leaf CUs which are X₁, X₂, X₃ and X₄, with X₁ following immediately after X₀, X₂ following immediately after X₁, and so on. The number of RDOs in X₁ is three, while that for each of, X₂, X₃ and X₄ is six. Each of the CUS X₀-X₄ corresponds to a stage.

In FIG. 4, the dependencies are truncated between the stages of X₀ and X₁ (only the path with the lowest accumulated cost is referenced by X₁). The CU size is adopted as the condition to facilitate finer computational scalability. For CUs X₁ to X₄ with sizes of 8×8 pixels, beam search-based optimization is applied. Herein, the beam size b₁=b₂=b₃=b₄=2, and the decision space [symbol] ={α, β, χ}. At X₁, [symbol] ₁={α, χ}. Then, for X₂, the two paths for [symbol] ₂ out of {α-α, α-β, α-χ, χ-α, χ-β, χ-χ} with the lowest accumulated costs

$${C}_{2}^{′} ( {m}_{2} , {\tilde{M}}_{1} )$$

(assuming the two paths are {α-α, χ-α} in this example) are selected. Repeating the updating step, when X₄ finishes the final decision, the 2 optimal paths from X₁ to X₄ are (χ-α-β-α) and (χ-α-β-β), respectively. The whole complexity of the beam search process is O(nbq) if b₁=b₂=b₃=b₄=b. When b=1, the beam search is reduced to a greedy search. It is worth mentioning that in the BSJRDO scheme, for the nonsplit decision of Xᵢ₊₁, following the Hadamard-based preselection procedure, only combinations of predictions and transforms sent to the full RDO calculation are considered effective candidates of mᵢ₊₁.

Subsequently, to make the beam search-based optimization process implementation-friendly and better fit the QT-MTT partitioning scheme, tailored designs are indispensable. Unlike a multilevel trellis [31], where the trellis is fully connected from the bottom to the top of a partitioning tree, the dependencies of CUs from different partitioning depths are truncated according to one embodiment of the invention. Once the ensuing sibling CU falls into a further partition, the first child of that sibling only refers to the best path (that is, reducing the number of decision paths to one) at its parent's preceding sibling CU. As such, neither heavy global picture-level buffers nor frequent cross-depth buffer access is needed, and the buffer operations (e.g., swapping and copying) needed for the beam search can be performed locally within the same partitioning level. The coding complexity is further reduced since there is only one reference candidate near the truncation step. For example, in FIG. 4, the total number of RDO for QT is 3+6×3=21 instead of 6×4=24. To be more specific regarding truncation, if Xᵢ is a CTU-level CU, only the best path of [symbol] ᵢ is maintained for both the nonsplit and split modes of its ensuing sibling CU. If Xᵢ is a non-CTU CU, for the nonsplit decisions of its next sibling, bᵢ best paths are prepared, and if the next sibling CU is split into ne child CUs, denoted by Xᵢ₊₁, . . . , Mᵢ₊ₙ_{_{c}}, then only the best path in [symbol] ᵢ is available for Xᵢ₊₁. Starting from Xᵢ₊₁, a new trellis is established. An illustration of the above-mentioned rules for truncation is shown in FIG. 4. For X₀'s 16×16 right sibling CUs, two best paths at X₀ are available for the RDO of the nonsplit modes (which are greyed out in FIG. 4), since X₀ is a CTU-level CU. After the partitioning decision of BT and TT, QT is conducted. Let the four 8×8 leaf CUs be X₁, X₂, X₃ and X₄. Due to the truncation of the BSJRDO scheme, only the best path at X₀ is referenced by X₁. In comparison, there are two best paths from X₁ that are referenced by X₂ because X₁ is a non-CTU CU. Similarly, X₂-X₄ are all non-CTU CU so there are two best paths (as in this example the beam size for all the corresponding stages are two) from each of X₂-X₄ that are referenced by their respective next stages.

After finishing the encoding of X₁ to X₄, the G-BFOS algorithm collects the best b₄ paths from X₁ to X₄ under QT partitioning for comparison and updating purposes. In addition, the G-BFOS algorithm also collects two best paths (i.e., a path with the lowest accumulated cost and a path with the second-lowest accumulated cost) from each of the Nonsplit CU and the BT/TT partitioned CU (which are greyed out in FIG. 4). It should be noted that the BSJRDO scheme utilizes an extended G-BFOS algorithm, because conventionally in G-BFOS algorithm, from the bottom leaf-node CUs to the top root CU of a partitioning tree, the encoder recursively compares the best decision of the parent CU with that of its partitioned child CUs. However, in the BSJRDO scheme, to fit the joint optimization scheme, instead of caching the best decision, b-best decisions are collected during the parent-children comparison of the extended G-BFOS algorithm. The two best paths from the QT CUs (thus from X₄), from the nonsplit CU and from the BT/TT partitioned CU, are compared by the G-BFOS algorithm. The output of the G-BFOS algorithm is two best paths that are provided to the next 16×16 CU.

Finally, defining the beam size bᵢ uniformly for all CUs only produces coarse-grained computational scalability, such that it is less R-D favorable for the encoder when accommodating the complexity constraint. To facilitate fine-grained computational scalability and better serve as practical performance-boosting solutions, in one embodiment of the invention it is possible the beam size bᵢ is adjusted based on the characteristics of Xᵢ. To verify the effectiveness of this strategy, the CU size is introduced in the BSJRDO scheme as a determinant condition, and all bᵢ values are controlled by an extra free hyperparameter s_{d}. Let wᵢ and hᵢ be the width and height of CU Xᵢ, respectively. The beam size is adjusted according to the following principle:

$${b}_{i} = \{ \begin{matrix}b , & if min ( {w}_{i} , {h}_{i} ) \leq {s}_{d} \\ {b}_{i}^{′} , & otherwise\end{matrix} \qquad ( 10 )$$

where b is the initial global beam size and b′ᵢ is the adjusted beam size, which is assumed to be smaller than b.

Herein, the connections between the BSJRDO scheme in the exemplary embodiments above and the RSVA are discussed, where RSVA has been adopted in other joint optimization problems concerning video coding (e.g., motion estimation and residual coding [23], [26], [31], [34]). bᵢ is also used to indicate the number of reduced states in the RSVA in the following paragraphs for unification with the concept of the beam size. Utilizing the same accumulated Lagrangian cost as that of the deterministic space-reduction measure, it is shown that the RSVA may be viewed as a stochastic version of the beam search algorithm. More specifically, supposing that all the beam sizes are uniformly assigned as b, the j^{th}-best decision of the RSVA is randomly ranked within the range of the [j, (j−1) b+1]^{th} position over the decision space of the beam search. As j and b increase, the probability that the RSVA falls into a ranking that is far worse than the j^{th} position increases.

In the RSVA, the Markovian order k is first set to 1 to alleviate the exponential-order complexity, and the recursive formulation of Eqn. (7) is given by

$${C}_{i + 1} ( {m}_{i + 1} ) = {min}_{{m}_{i}} \{ {C}_{i} ( {m}_{i} ) + {J}_{i + 1} ( {m}_{i + 1} , {m}_{i} ) \} \qquad ( 11 )$$

with a complexity of O(nq²). Analogous to the updating scheme in Eqn. (9), to further reduce the decision space, paths \tilde{M}ᵢ from a reduced space [symbol] ᵢ (| [symbol] ᵢ|=bᵢ) are maintained for the utilization of Xᵢ₊₁ based on the accumulated cost. The main difference here is that the final decision mᵢ of each path \tilde{M}ᵢ is always distinct. In other words, the RSVA always selects the “unique states” of the trellis. In FIG. 3, supposing that bᵢ=2 out of 3 paths are reserved in every stage by the RSVA, the ending states of the two paths should have distinct values from Mᵢ. In comparison, the beam search algorithm illustrated in FIG. 4 has no such constraints. The paths in different stages may have the same state.

Mathematically, suppose that both the RSVA and the beam search start with the same reduced space [symbol] ᵢ at Xᵢ. Let

$${\tilde{M}}_{i + 1}^{V} ∈ {\tilde{B}}_{i + 1}^{V} {\tilde{M}}_{i + 1}^{B} ∈ {\tilde{B}}_{i + 1}^{B} ( \vert {\tilde{B}}_{i + 1}^{V} \vert = \vert {\tilde{B}}_{i + 1}^{B} \vert = b )$$

be the paths obtained by the RSVA and the beam search at Xᵢ₊₁, respectively. Apparently, if the

$${\tilde{M}}_{i + 1}^{B}$$

obtained by Eqn. (9) happens to have distinct decisions for mᵢ₊₁, then

$${\tilde{B}}_{i + 1}^{B} = {\tilde{B}}_{i + 1}^{V} .$$

### Otherwise,

$${\tilde{M}}_{i + 1}^{V}$$

should never be the b path with the lowest accumulated cost for

$${C}_{i + 1}^{′} ( {m}_{i + 1} , {\tilde{M}}_{i} ) .$$

Without loss of generality, let (m_{i+1,1}, \tilde{M}_{i,1}), . . . , (m_{i+1,b}, \tilde{M}_{i,b}) be the b paths obtained by the RSVA with

$${C}_{i + 1}^{′} ( {m}_{i + 1 , 1} , {\tilde{M}}_{i , 1} ) \leq … \leq {C}_{i + 1}^{′} ( {m}_{i + 1 , b} , {\tilde{M}}_{i , b} ) , where \\ {m}_{i + 1 , 1} \neq {m}_{i + 1 , 2} \neq … \neq {m}_{i + 1 , b} \qquad ( 12 )$$

For any j∈[1, b], (m_{i+1,j}, \tilde{M}_{i,j}) is the best path out of the b total paths of (mᵢ₊₁, \tilde{M}ᵢ), which indicates that

$${\tilde{M}}_{i , j} = {arg min}_{{\tilde{M}}_{i}} {C}_{i + 1}^{′} ( {m}_{i + 1 , j} , {\tilde{M}}_{i} ) \qquad ( 13 )$$

In the best case,

$${C}_{i + 1}^{′} ( {m}_{i + 1 , j} , {\tilde{M}}_{i , j} )$$

is ranked at the j^{th} position (in ascending order) out of the qb candidates of

$${C}_{i + 1}^{′} ( {m}_{i + 1} , {\tilde{M}}_{i} )$$

with

$${C}_{i + 1}^{′} ( {m}_{i + 1 , j} , {\tilde{M}}_{i , j} ) \leq {min}_{{\tilde{M}}_{i} \neq {\tilde{M}}_{i} , k} {C}_{i + 1}^{′} ( {m}_{i + 1} , {\tilde{M}}_{i} ) , for ∀ k ∈ [ 1 , j ) \qquad ( 14 )$$

which is exactly the j^{th} best solution of the beam search. In the worst case,

$${C}_{i + 1}^{′} ( {m}_{i + 1 , j} , {\tilde{M}}_{i , j} )$$

is ranked at the ((j−1) b+1)^{th} position with

$${C}_{i + 1}^{′} ( {m}_{i + 1 , j} , {\tilde{M}}_{i , j} ) > max {C}_{i + 1}^{′} ( {m}_{i + 1 , k} , {\tilde{M}}_{i} ) , for ∀ k ∈ [ 1 , j ) \qquad ( 15 )$$

As such, the ranking of

$${C}_{i + 1}^{′} ( {m}_{i + 1 , j} , {\tilde{M}}_{i , j} )$$

can thus be viewed as a random variable with possible values taken from [j, (j−1) b+1)].

In the next section, performance of the BSJRDO scheme is experimentally validated on VTM-12.0. The compression performance achieved in terms of the BDBR and the corresponding encoding time are reported to demonstrate the R-D bounds and scalability. The performance of the RSVA discussed above is also reported.

As highlighted in FIG. 2, for the RDO process of nonsplit modes, both the reconstruction buffers and entropy contexts of the bᵢ best combinations of prediction modes and transform modes are cached for one reference path ended at Xᵢ₋₁. Then, with bᵢ₋₁ different reference paths, a total of bᵢbᵢ₋₁ candidates are attained. Since the sorting algorithm is crucial for the G-BFOS updating process and the overall encoding time, the quick sort is adopted to sort the final bᵢ paths out of the bᵢbᵢ₋₁ candidates in the implementation. For the beam size accommodation in Eqn. (10), ideally, if the predefined condition is not satisfied, b′ᵢ can be adjusted to any values that are within the range of [1, b−1] to facilitate finer granularity. Herein, b′ᵢ is directly set to 1 if the CU size is smaller than s_{d}. A similar mechanism is also implemented for chroma coding after performing luma coding. For the QP determination, the default fixed QP scheme provided by VTM-12.0 is followed. For the fast partitioning algorithms in VTM-12.0, the information of the best candidate is used for determination purposes. In addition, the acceleration technique of reusing the cached CU results [42] is turned off for both the anchor (default VTM-12.0) and the results of the BSJRDO scheme. For the RSVA, the implementation details discussed above are identical.

All test sequences in the VVC common test conditions (CTC) for standard-dynamic-range (SDR) videos [43] are encoded with the default AI configuration under the CTC condition (QP 22˜37). BDBR-Y, BDBR-U, BDBR-V and BDBR-YUV are used to evaluate the resulting R-D performance, for which negative values represent coding gains. The Y:U:V ratio used to compute the PSNR of YUV is 6:1:1. The normalized encoding time Γ_{EncT} is calculated by

$${Γ}_{E n c T} = \frac{{T}_{t}}{{T}_{a}} \qquad ( 16 )$$

where Tₐ is the overall encoding time of the anchor and Tₜ is the corresponding encoding time achieved with the BSJRDO scheme. For the encoding time calculation, the average of four QPs is adopted.

In Table I, the performance achieved by the BSJRDO scheme with b=10 and s_{d}=64 under the VVC AI configuration is presented. In addition to the CTC (QP22˜37), the performance attained under low-bit-rate (LBR) conditions (QP42˜57) is also examined. As shown in Table I, the bit rate savings of the LBR conditions are larger than those of the CTC. In particular, with an approximately tenfold increase in encoding complexity, the BSJRDO scheme can achieve −1.30% and −3.22% BDBR-YUV (class A1 to class F) for the CTC and the LBR conditions, respectively. This can be viewed as the new achievable R-D bound for VVC intra coding. More specifically, the maximum BDBR-YUV for a single sequence is achieved by Tango2 with −2.44% and −5.15% under the CTC and the LRB, respectively, indicating consider-able room for further optimization. The possible coding gain is least noticeable for class D with a resolution of 416×240, for which the bit rate savings of YUV are 1.04% and 1.97% for the CTC and the LBR conditions, respectively. Next, seven 8K SDR videos from HHI-Berlin Test Sequences [44] are further tested. Each of these sequences is a 10-bit sequence and has 600 frames. As shown in Table I, one can observe that the resolution is a less decisive factor for the BSJRDO scheme when achieving a better bound under the CTC. The average BDBR-YUV for the tested 8K sequences under the CTC is-1.16%. However, under the LBR conditions, there is an obvious trend: as the resolution increases, more coding gains can be obtained, from the −1.97% BDBR-YUV of class D to the −4.60% BDBR-YUV of the 8K sequences. For the chroma components, this trend is even more significant, from the −3.48% BDBR-V of class D to the −20.32% BDBR-V of the 8K sequences. An explanation for this finding is that under the LBR conditions and especially for the chroma components, as the resolution increases, the shallower CTUs are partitioned (early terminated by the embedded fast algorithms [42]). A smaller and thus less optimal decision space is explored by the encoder, leaving more room for optimization in the BSJRDO scheme.

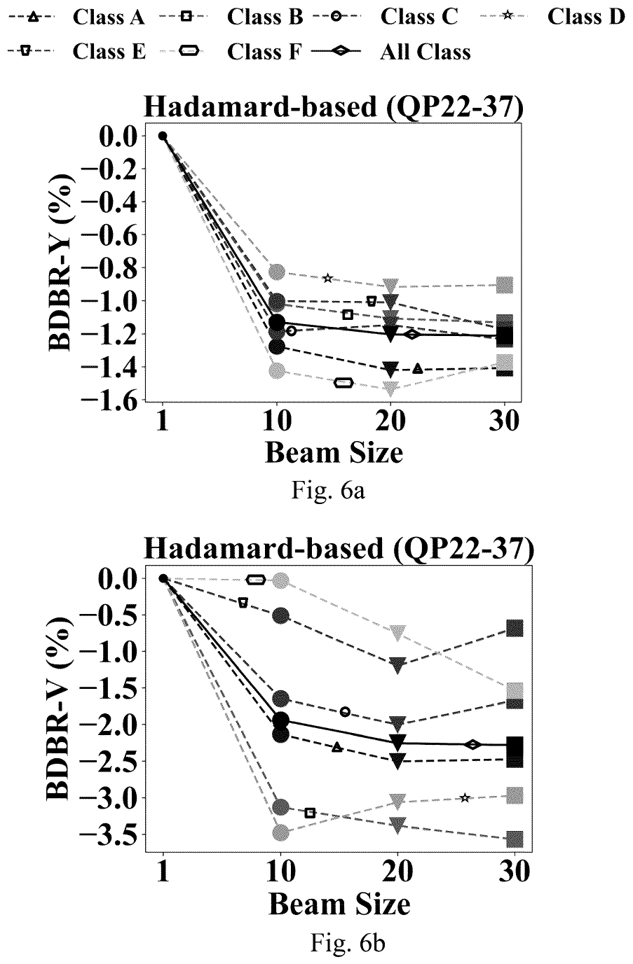

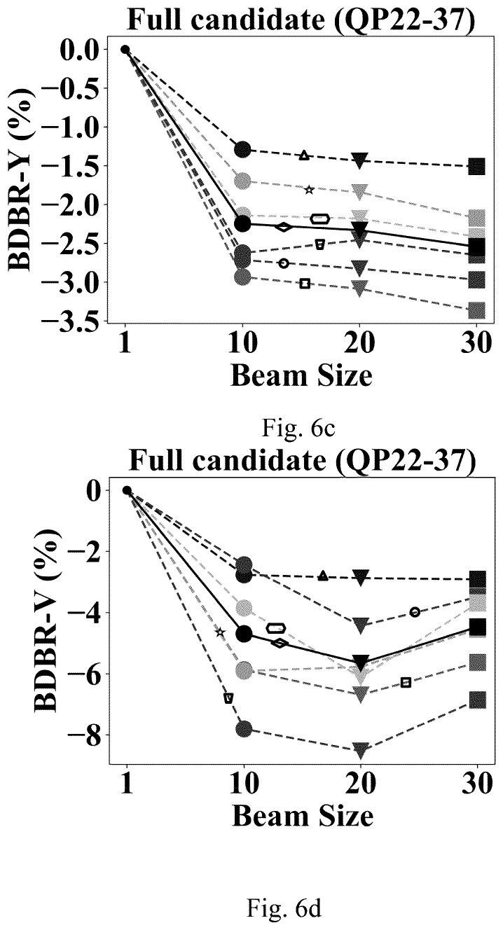

To further validate the BSJRDO scheme in a broader candidate space, the coding performance achieved with beam sizes b={10, 20, 30} and s_{d}=64 under the CTC is examined. Both the results obtained on a vanilla Hadamard-based encoder and a full-candidate encoder are provided in FIGS. 6a-6d. Only the first frame of each sequence is tested. Considering the computational complexity, only the first frame of each CTC sequence is encoded, and the coding results acquired from the same class are averaged. Generally, since the trends of the U and V components are quite close, only the BDBR-V results are presented. As shown in FIGS. 6a-6d, with increasing beam size b, the coding performance moderately improves. More specifically, the average BDBR-Y values obtained for all sequences with b={10, 20, 30} are −1.13%, −1.20%, and −1.21%. The corresponding BDBR-V results are −1.94%, −2.25% and −2.28%, respectively. It is observed that for some classes, especially for the chroma results, the performance is not always improved as the beam size increases. However, overall, the data show that the YUV gain is still gradually improved. In terms of encoding time, since sorting can take up a large part of the computational complexity with a large decision space, for the case with b=30, the encoding time is increased nearly 160 times. In FIGS. 6c-6d, a full-candidate encoder is used as the anchor (b=1) and the BSJRDO scheme is applied. The full-candidate encoder disables the Hadamard-based candidate preselection process discussed previously and conducts (almost) a full-candidate search of 67 regular modes, 6 MPMs with 2 extra reference lines, full MIP candidates, and ISP with 67 regular candidate modes during the luma RDO procedure. As shown in FIGS. 6c-6d, a similar trend can be concluded after b>10. However, the achievable coding gain is significant. The BDBR-Y and BDBR-V are −2.54% and −5.66% when b=30, respectively, which are over twice the bit rate savings of the Hadamard-based scheme.

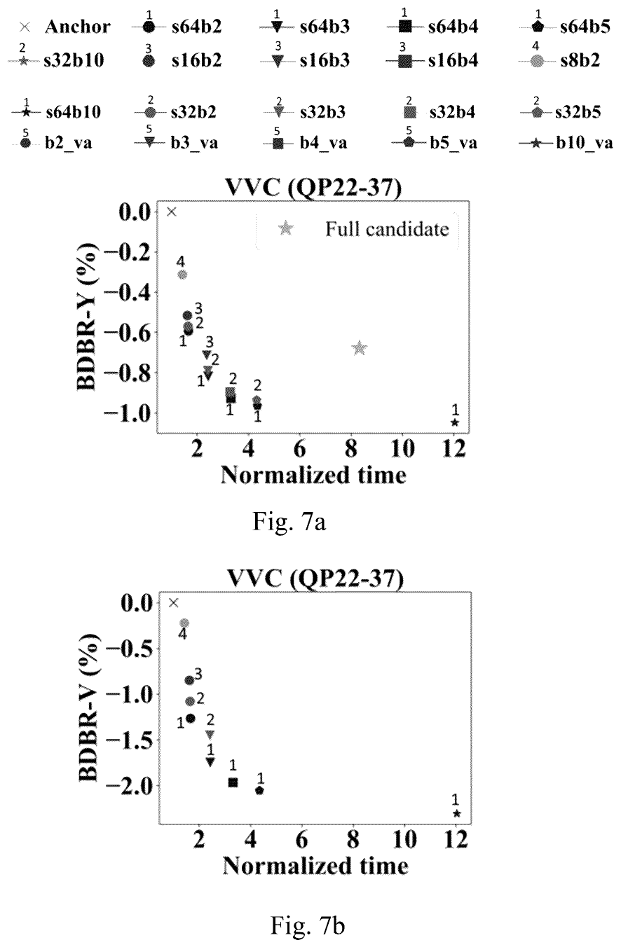

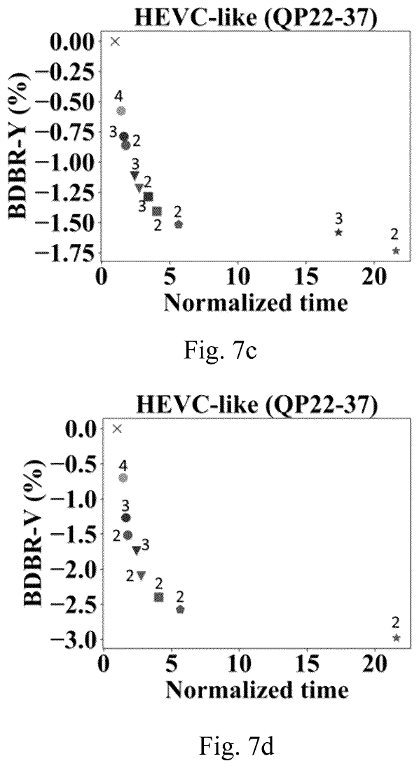

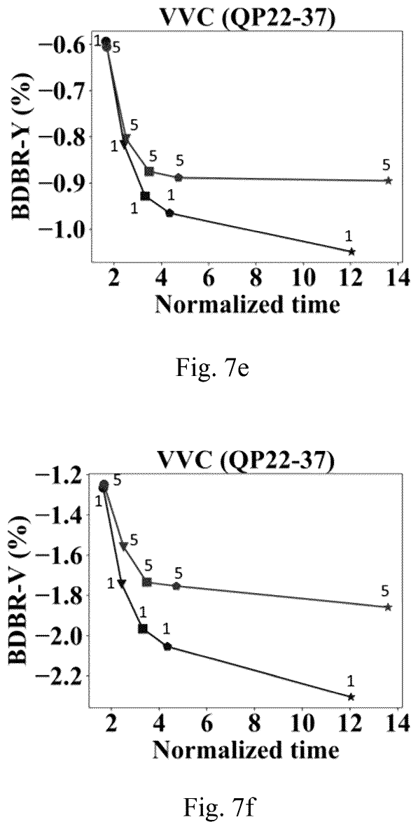

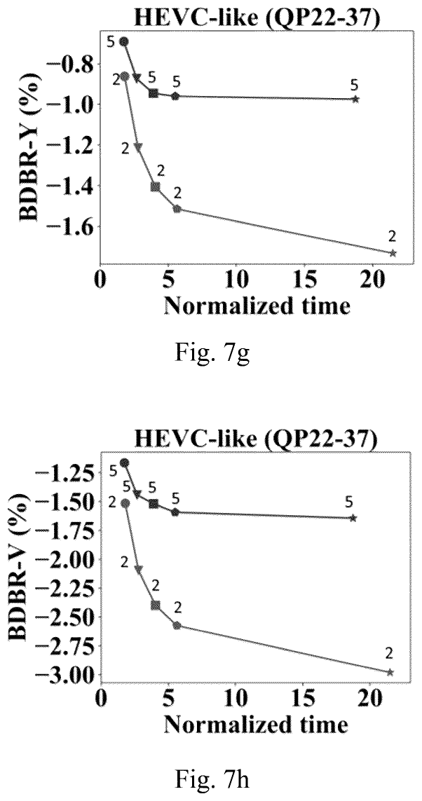

Next, the performance-boosting potential of the BSJRDO scheme for practical encoders with different computational capacities is demonstrated in FIGS. 7a-7h, where the scalable performance is presented. An HEVC-like environment is configured to mimic the performance of the BSJRDO scheme on HEVC. For the HEVC-like configuration, most of the new tools introduced in VVC intra coding [45] are manually turned off, including the MTT, MTS, LFNST, ISP, MIP, MRL, DQ, LMCS, ALF, and the joint coding of chroma residuals (JCCR). The CTU size is set from 128 to 64, and the separate chroma tree is turned on due to the VTM-12.0 software constraints. In particular, the beam size b={2, 3, 4, 5, 10} is experimentally examined with each value controlled within s_{d}={64, 32, 16, 8}. The operational set containing the points that are optimal in terms of the R-D performance achieved for VVC and the HEVC-like configuration are shown in FIGS. 7a-7d. For the HEVC-like configuration, s_{d}=32. The “b10” results, which were discussed earlier with more details, are also shown in the same figures. For the RSVA, the performances achieved for b={2, 3, 4, 5, 10} with s_{d}=64 are compared in FIGS. 7c-7h. In FIGS. 7a-7g, the results obtained with different coding settings are indicated by “sXbY” in the legend, where X and Y represent the values of s_{d} and b, respectively. The anchor is “s64b1”, and the results of the RSVA are indicated with the suffix “va”. For every point in the figures, the average BDBR and the normalized time Γ_{EncT} for all test sequence are calculated. The performance of a comparison RDO algorithm that conducts the full-candidate search during luma coding is marked as “Full candidate” in FIG. 7a.

As shown in FIG. 7a, with the nonuniform beam size configuration, more points are included in the operational set than those obtained by simply varying a global b. For the VVC AI configuration, experiments show that the BSJRDO scheme is effective and provides finer scalability. To be more specific, with a uniform bᵢ, to achieve better coding results, the nearest point in the operational set to the anchor is “s64b2”, for which the results are −0.59% BDBR-Y with 66% extra encoding time. After introducing s_{d}, fine-grained complexity options are enabled. The closest point becomes “s8b2” with a BDBR-Y performance of −0.31% and 42% extra encoding time. When the complexity lies in the range between “s64b2” and the “s64b5”, experiments show that “s16b3” is a good supplement for the operational set. Moreover, it is observed that adjusting s_{d} from 64 to 32 does not cause significant performance variations for the Y component, and the average normalized complexity interval for the “s64” points within this range is approximately 89%. For the BDBR-V in FIG. 7b, a similar operational set is observed. Overall, the operational point with the best complexity-efficiency tradeoff (i.e., with the steepest slope compared to the anchor) is “s64b2”, for which the BDBR-YUV is −0.73% and the extra encoding time is 66%. For the HEVC-like results in FIGS. 7c-7d, since the maximum CTU size is 64, only the “s32” results are valid. Herein, with the BSJRDO scheme, the closest point “s8b2” yields a −0.58% BDBR-Y with 44% extra encoding time. For the complexity range between “s32b2” and “s32b5”, the “s16b3” and “s16b4” points supplement the operational set, and the average normalized complexity interval within this range is decreased from 128% to 77%. In terms of the best complexity-efficiency tradeoff point, the “s32b2” point achieving a −1.00% BDBR-YUV with 79% extra encoding time outperforms the others.

To demonstrate the superiority of the BSJRDO scheme, the scheme is compared with the full-candidate encoder. As shown in FIG. 7a, with the full-candidate search, 0.68% bit rate savings for the luma component are achieved at the expense of 733% extra encoding time, while for the BSJRDO scheme, an operational point with similar R-D performance, “s16b3”, can achieve 0.71% bit rate savings with only 136% extra encoding time. It is worth mentioning that the algorithm is only implemented on the verification model, i.e., the VTM, which runs on a single thread. For the updating process in Eqn. (9), it is possible to obtain the candidates of (mᵢ₊₁, \tilde{M}_{i,1}), . . . , (mᵢ₊₁, \tilde{M}_{i,b}) in a parallel manner [46].

For example, in FIG. 4, regarding the candidate search for X₂, the paths {α-α, α-β, α-χ} and {χ-α, χ-β, χ-χ} can be processed simultaneously. The encoding time can thus be further accelerated with multithreading. In FIGS. 7e-7h, the performance of the RSVA is demonstrated. In particular, the RSVA is inferior to the BSJRDO scheme under the VVC AI configuration. As discussed earlier, due to the stochastic nature of the RSVA, more paths considered to be “low-ranking” paths can possibly be incorporated into the candidate space as b increases, which may cause overall performance degradation. When b=10, the performance gaps between the BSJRDO scheme and the RSVA are 0.15% and 0.45% for the BDBR-Y and BDBR-V, respectively, under the VVC configuration. For the HEVC-like configuration, the gaps are even larger.

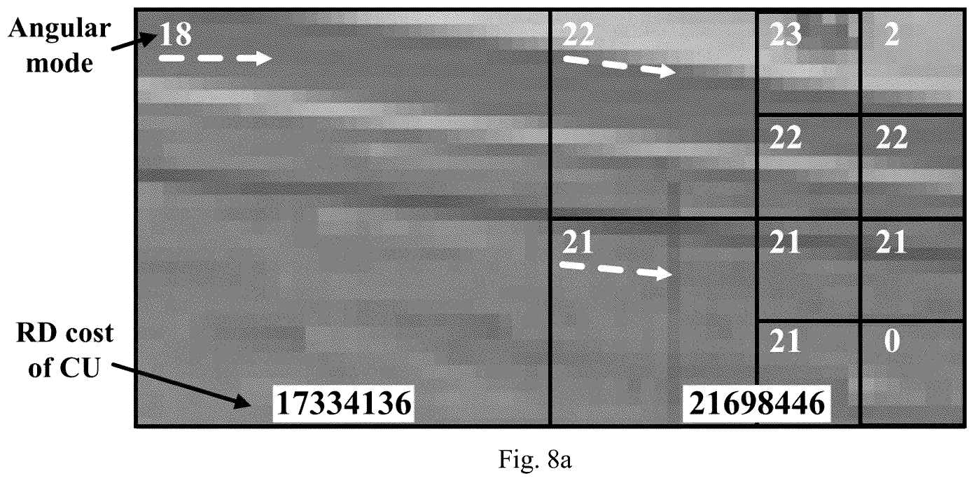

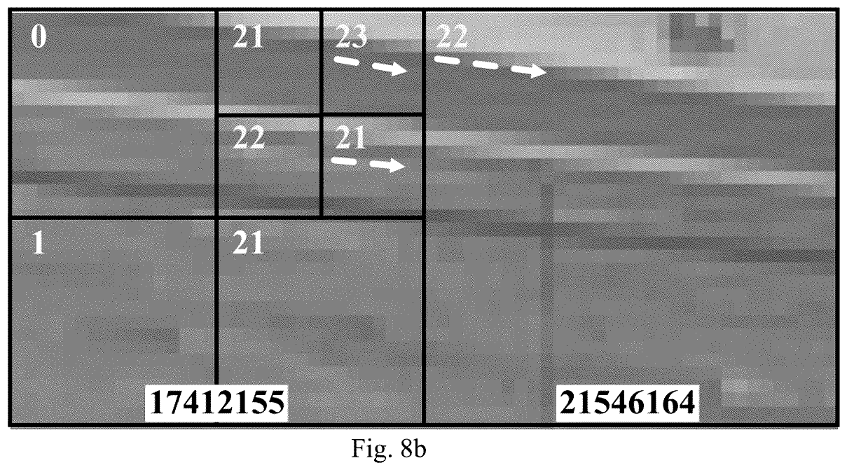

In FIGS. 8a-8b, more insights are provided regarding how the BSJRDO scheme improves the final coding performance. The encoding results in FIG. 8a and FIG. 8b are obtained under the HEVC-like configuration with b=1 and b=2, respectively. In FIGS. 8a-8b, the angular prediction modes of the CUs are marked in the upper-left corner, and the directions of modes 18, 21, 22 and 23 are indicated with dotted lines. One may refer to the 32×32 CUs on the left-hand side and right-hand side as Xₗ and Xᵣ, respectively. In FIG. 8a, when Xₗ and Xᵣ are independently optimized, the locally optimal decisions provide us with a total R-D cost of 3.9032×10⁷. In FIG. 8b, when the dependencies are considered, a better R-D cost of 3.8958×10⁷ is attained. The performance gain can be explained as follows. As seen in FIGS. 8a-8b, the content has strong directional characteristics (around the angle of mode 22). When a “short-sighted” horizontal angular prediction (mode 18) is selected for Xₗ in FIG. 8a, it is apparent that the local R-D cost is better than that of the partitioning decision for Xₗ in FIG. 8b. However, since the horizontal prediction deviates from the main texture direction (mode 22), the quality of the reference boundary for Xᵣ may not be optimal. In FIG. 8b, as the reference boundary for Xᵣ is predicted by the more reasonable modes of 23 and 21 derived from two 8×8 sub-CUs, Xᵣ can achieve a lower R-D cost.

In summary, one can see that the exemplary embodiments shown in FIGS. 2 and 4 provide a R-D bound-pushing algorithm and the practical performance-boosting solution for VVC intra coding. In particular, a BSJRDO scheme tailored for VVC intra coding is provided. The core of this scheme is the beam search, where the joint RDO problem can be elegantly represented by a trellis. At every stage of the trellis, decisions (partitioning, prediction and transform) from a customized small subspace will be selected as candidates for the RDO of the following CUs. As such, the dependency among CUs is introduced into the optimization in a low-complexity way. With a reduced decision space, the BSJRDO scheme is capable of jointly optimizing the partitioning, prediction and transform decisions. The joint optimization is conducted based on a well-defined candidate evaluation measure. By enabling flexible and nonuniform beam size configurations, operational points with different complexity-efficiency tradeoffs are obtained, among which the best result shows that 0.73% bit savings can be achieved at the expense of 66% extra encoding time.

Embodiments of the invention open up new space for the exploration of encoder optimization methods for VVC, and the BSJRDO scheme can be conceivably extended to other optimization scenarios such as VVC inter coding. Moreover, as a new operational bound is obtained by BSJRDO, how more computationally efficient algorithms can be designed to approach this bound is also worth investigating. The learning-based method is a promising solution [47], [48]. As such, an encoder can be produced with less coding time but better R-D performance than that of the anchor.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

The functional units and modules of the systems and methods in accordance with the embodiments disclosed herein may be implemented using computing devices, computer processors, or electronic circuitries including but not limited to application-specific integrated circuits (ASIC), field programmable gate arrays (FPGA), and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance with the embodiments may be executed in one or more computing devices including server computers, personal computers, laptop computers, and mobile computing devices such as smartphones and tablet computers.

The embodiments include computer storage media, transient and non-transient memory devices having computer instructions or software codes stored therein which can be used to program computers or microprocessors to perform any of the processes of the present invention. The storage media, transient and non-transitory computer-readable storage medium can include but are not limited to floppy disks, optical discs, Blu-ray Disc, DVD, CD-ROMs, magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in a distributed fashion by one or more processing devices interconnected by a communication network, such as an intranet, WAN, LAN, the Internet, and other forms of data transmission medium.

It should be noted that although the BSJRDO scheme described above and illustrated in FIG. 4 according to an exemplary embodiment of the invention includes the various techniques which include 1) the beam search (with optionally an adjustable beam size); and 2) truncation of the dependencies between CUs at different depths, the invention is not limited to use of all these techniques at the same time in a single optimization process. Rather, in one example the beam search may be carried out for a customized search subset with a fixed beam size for all stages, and without truncation of the dependencies between CUs at different depths. In another example, the beam search may be carried out with a fixed beam size, and with truncation of the dependencies between CUs at different depths. of All these variations fall into the scope of the invention.

It should be noted that numerals such as 0, 1, 2, 3, 4 . . . that are used to represent the index i in for example Xᵢ, mᵢ, [symbol] ᵢ, bᵢ should not be construed as absolute ordering. Rather, the choices of these numerals are for illustration purposes only. For example, depending on where the sequence starts, a CU which is X₀ may not necessarily be the first CU in the whole encoding scheme, as it may be a later CU other than the first one.

1. A computer-implemented method for optimizing a video encoder, comprising the steps of:
a) defining a plurality of coding units (CUs) of the video encoder that correspond to a plurality of stages; the plurality of stages comprising a first stage, and a second stage immediately after the first stage;
b) providing a decision space of encoding parameters of the video encoder; and
c) defining, for the second stage, a subspace being a subset of the decision space; the subspace comprising b₁ optimal decision paths from the first stage to the second stage, wherein b₁ is defined as a beam size for the first stage;
wherein the b₁ optimal decision paths are the b₁ decision paths that have lowest accumulated cost among all decision paths from the first stage to the second stage.

2. The computer-implemented method of claim 1, wherein the plurality of stages further comprises a third stage immediately before the first stage; the method further comprising:
d) truncating dependencies between the third stage and the first stage.

3. The computer-implemented method of claim 2, wherein Step d) further comprises reducing the number of decision paths from the third stage to the first stage to one.

4. The computer-implemented method of claim 3, wherein a third CU corresponding to the third stage is at coding-tree-unit (CTU) level.

5. The computer-implemented method of claim 3, wherein a third CU corresponding to the third stage is from a different partitioning depth compared to that of a first CU corresponding to the first stage.

6. The computer-implemented method of claim 1, wherein the plurality of stages further comprises a third stage immediately after the second stage; the method further comprising:
e) defining, for the third stage, a subspace being a subset of the decision space; the subspace comprising b₂ optimal decision paths from the first stage to the third stage, wherein b₂ is defined as a beam size for the second stage;
wherein the b₂ optimal decision paths are the b₂ decision paths that have lowest accumulated cost among all decision paths from the first stage to the stage.

7. The computer-implemented method of claim 6, wherein b₁ is different from b₂.

8. The computer-implemented method of claim 6, wherein b₁ is the same as b₂.

9. The computer-implemented method of claim 6, wherein the b₂ optimal decision paths are collected by a generalized Breiman, Friedman, Olshen and Stone (G-BFOS) algorithm; the G-BFOS algorithm adapted to compare the b₂ optimal decision paths with those from one of the plurality of stages other than the first, second and third stages.

10. The computer-implemented method of claim 1, further comprises the step of determining a beam size for each of the plurality of stages.

11. The computer-implemented method of claim 10, wherein the beam size for each of the stages is determined based on characteristics of a corresponding one of the plurality of CUs.

12. The computer-implemented method of claim 11, wherein the characteristics of the corresponding CU comprise a width and a height of the corresponding CU.

13. The computer-implemented method of claim 1, wherein the decision space comprises partitioning decision, prediction decisions or transform decisions.

14. The computer-implemented method of claim 1, wherein the video encoder is versatile video coding (VVC).

15. A non-transitory computer-readable memory recording medium having computer instructions recorded thereon, the computer instructions, when executed on one or more processors, causing the one or more processors to perform operations according to the method according to claim 1.

16. A computing system comprising:
one or more processors; and
memory containing instructions that, when executed by the one or more processors, cause the computing system to perform operations according to the method of claim 1.
